(19) United States
(12) Patent Application Publication
(10) Pub. No.: US 2022/0147668 A1
(43) Pub. Date: May 12, 2022

(54) REDUCING BURN-IN FOR MONTE-CARLO SIMULATIONS VIA MACHINE LEARNING

(71) Applicant: Advanced Micro Devices, Inc., Santa Clara, CA (US)

(72) Inventors: Nicholas Malaya, Austin, TX (US); Jakub Kurzak, Santa Clara, CA (US)

(73) Assignee: Advanced Micro Devices, Inc., Santa Clara, CA (US)

(21) Appl. No.: 17/094,690

(22) Filed: Nov. 10, 2020

(51) Int. Cl. G06F 30/27; G06F 17/18; G06K 9/62

(52) U.S. Cl. CPC G06F 30/27; G06F 2111/08; G06K 9/6256; G06F 17/18

(57) ABSTRACT

Techniques are disclosed for compressing data. The techniques include identifying, in data to be compressed, a first set of values, wherein the first set of values include a first number of two or more consecutive identical non-zero values; including, in compressed data, a first control value indicating the first number of non-zero values and a first data item corresponding to the consecutive identical non-zero values; identifying, in the data to be compressed, a second value having an exponent value included in a defined set of exponent values; including, in the compressed data, a second control value indicating the exponent value and a second data item corresponding to a portion of the second value other than the exponent value; and including, in the compressed data, a third control value indicating a third set of one or more consecutive zero values in the data to be compressed.

### BACKGROUND

A Monte Carlo simulation is a simulation in which a probability distribution is estimated by generating random samples and categorizing those random samples to generate the estimate. Some forms of Monte Carlo simulations are subject to a burn-in phenomenon, in which a large number of initial samples are generated and discarded. Burn-in represents a large portion of simulation time.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 illustrates operations associated with a Markov-Chain Monte-Carlo simulation, according to an example;

FIG. 3 illustrates a graph showing a sample distribution generated by a Markov Chain Monte Carlo simulator, according to an example;

FIG. 4 illustrates a graph showing a measured distribution for samples taken in FIG. 3, according to an example;

FIG. 5 illustrates a training operation, according to an example;

FIG. 6 illustrates a simulator system for generating initial samples for a Markov Chain Monte Carlo simulation performed by a Monte Carlo simulator; and

FIG. 7 is a flow diagram of a method for performing a Monte Carlo simulation, according to an example.

### DETAILED DESCRIPTION

Techniques are disclosed for performing a Monte Carlo simulation. The techniques include obtaining an initial Monte Carlo simulation sample from a trained machine learning model, and including the initial Monte Carlo simulation sample in a sample distribution; generating a subsequent Monte Carlo simulation sample from a most recently included Monte Carlo simulation sample most recently included into the sample distribution; determining whether to include the subsequent Monte Carlo simulation sample into the sample distribution based on an inclusion criterion; and repeating the generating and determining steps until a termination criterion is met.

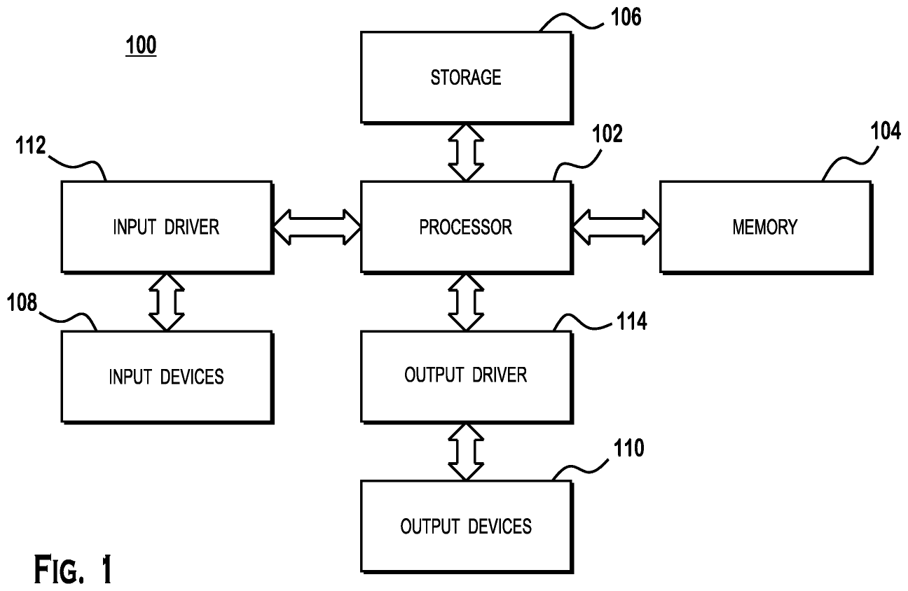

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110.

FIG. 2 illustrates operations associated with a Markov-Chain Monte-Carlo simulation, according to an example. A Monte Carlo simulation is a means of estimating a probability distribution by generating random samples and accepting or rejecting those random samples into an estimate of the probability distribution based on some criteria. The estimate is sometimes referred to herein as the “sample distribution.” A sample is an element of the probability distribution and can have any number of dimensions. In an example, a sample is a scalar value or a vector value, where the scalar value or each element of the vector value has some numerical value. An obvious criterion would be to compare the randomly generated samples to a description of the probability distribution that is being estimated (such as a mathematical function). However, Monte Carlo simulations can also be used to estimate probability distributions where a relatively small amount of knowledge of the probability distribution exists.

In a Markov Chain Monte Carlo (“MCMC”) simulation, a simulator performs a “walk” to generate samples for a sample distribution in sequence. The simulator generates any given sample by modifying an immediately prior sample by a random amount and determining whether to include the sample in the sample distribution based on some inclusion criteria. When this process is terminated, the sample distribution is considered to be an estimate of the probability distribution attempting to be determined.

FIG. 2 illustrates a graph 200 showing a small portion of a Markov Chain Monte Carlo simulation. A starting sample 202(1) is shown. A simulator generates a second sample 202(2) by making a random modification to the value of the first sample 202(1). The simulator determines whether to include the sample 202(2) in the sample distribution based on an inclusion criteria. In the example shown, the inclusion criteria indicates that the second sample 202(2) is to be rejected. Thus the simulator does not include the second sample 202(2) in the sample distribution. The simulator continues as shown, rejecting samples 202(3) and 202(4) and including samples 202(5), 202(6), and 202(7). Note, the arrows indicate that a sample 202 is generated from the sample at the beginning of the arrows. Note also that the graph 200 should not be interpreted as the samples 202 necessarily having scalar (i.e., a single) values. Instead, it should be understood that the values of the samples 202 can be scalar or vector values. For vector values, the simulator makes random modifications by modifying one or more of the component values of the vector.

There are a wide variety of possible inclusion criteria. One example dictated by the Metropolis-Hastings algorithm. To use this algorithm, it must be possible to calculate the ratio of densities of any two values in the true distribution (that is, the distribution attempting to be learned). A “density” or probability density function of a continuous random variable is a function whose value for any given sample in the sample space (the set of possible values for the continuous random variable) provides a relative likelihood that the value of the random variable would equal that sample.

According to the Metropolis-Hastings algorithm, the simulator selects a candidate sample by modifying a prior sample already included, for inclusion into the sample distribution. The simulator calculates the ratio of probability densities for the newly generated sample and the sample from which that sample was generated. If this ratio is greater than one, then the simulator includes the candidate sample into the sample distribution. If the ratio is not greater than one, then the simulator generates a random number between 0 and 1. If this random number is greater than the ratio, then the simulator rejects the random sample and if the random number is less than or equal to the ratio, then the simulator includes the random sample into the sample distribution. The simulator continues performing the above operations, generating new candidate samples and including or not including those samples into the sample distribution as described. The resultant sample distribution should converge to the true probability distribution given enough samples. Although the Metropolis-Hastings algorithm has been described as an example inclusion criteria, it should be understood that any technically feasible inclusion criteria could be used.

Although the sample distribution converges to the true distribution given enough samples, it is possible that such convergence would take an extremely large number of samples. This is because, if the initial sample is far from a location of “high probability,” and is thus in a location of “low probability,” then the simulator will have to generate a large number of samples before generating samples of relatively high probability. The samples generated in these areas of low probability will skew the sample distribution unless an extremely large number of samples are generated.

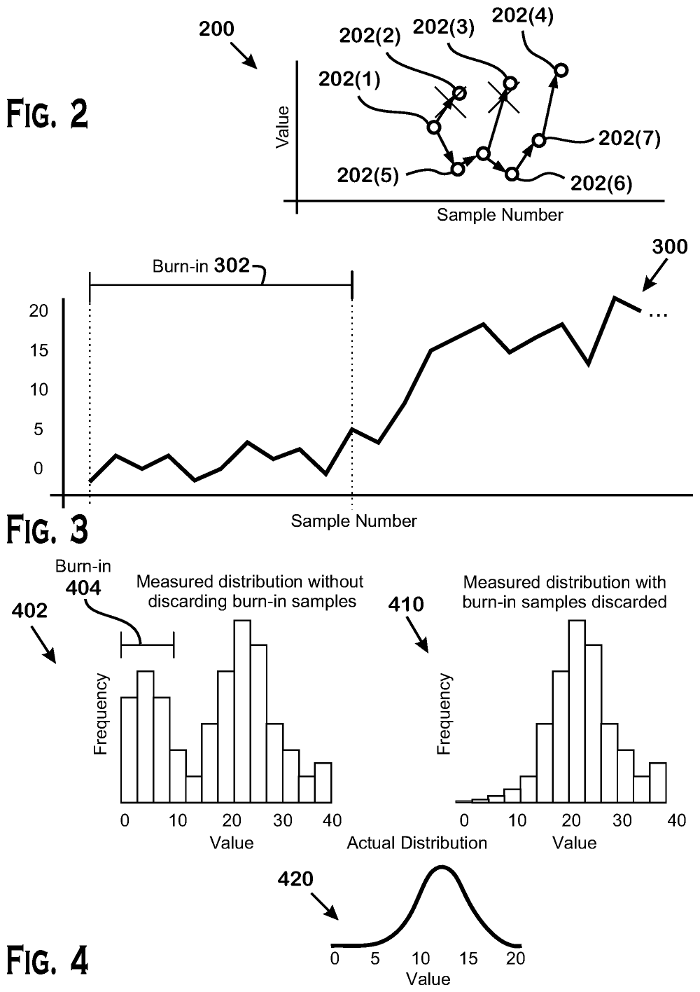

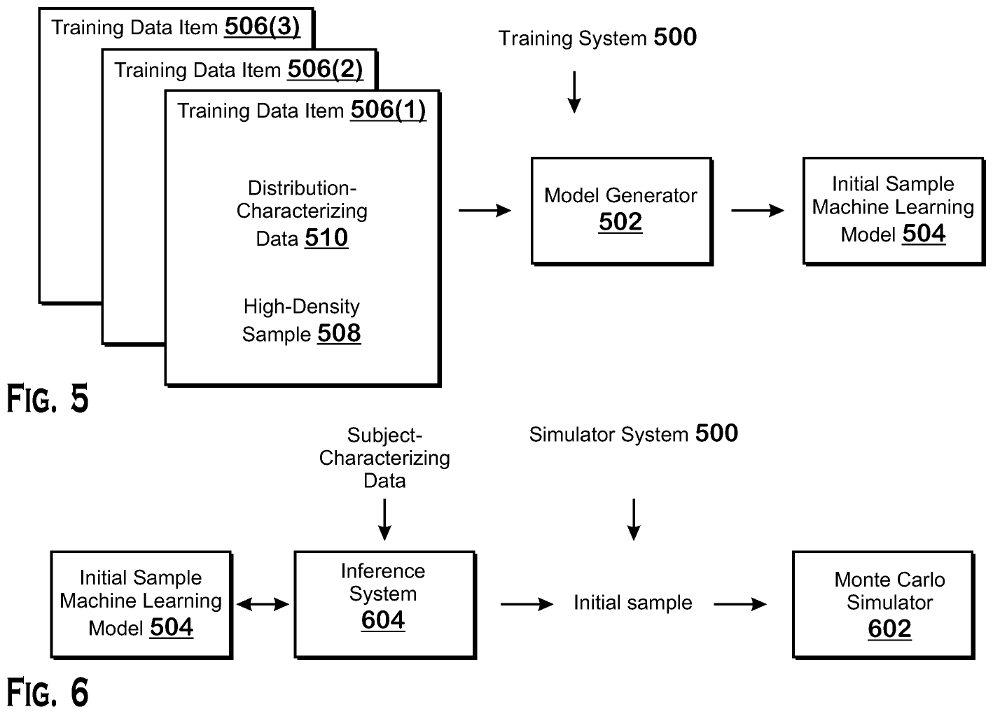

To counteract the above effect, a technique referred to as burn-in is frequently used. FIGS. 3 and 4 illustrate the concept of burn-in.

FIG. 3 illustrates a graph 300 showing a sample distribution generated by a Markov Chain Monte Carlo simulator, according to an example. In this example, the simulator generates a number of samples, shown in the burn-in period 302. These samples are not within an area of high probability. However, these samples contribute to a large degree to the overall sample distribution because the simulator must generate a large number of samples before “arriving” at an area of high probability. As shown in FIG. 3, the simulator “dwells” in the burn-in area 302 before obtaining samples to the right of the burn-in area.

In FIG. 4, graph 402 illustrates a measured distribution (e.g., sample distribution) for the samples taken in FIG. 3. As can be seen, a burn-in portion, corresponding to approximately values 0-10, is included in the graph 402. However, as shown in the actual distribution graph 420, this burn-in portion does not reflect the actual distribution 420. Graph 410, shown with the burn-in samples removed, illustrates a distribution that is closer to the actual distribution 420 than the graph 402 including the burn-in samples. Again, the reason for the inaccuracy of the graph 402 is that the simulator “dwells” in the burn-in area without “finding” the “correct” area of the actual distribution. This “dwelling” introduces large number of samples into the sample distribution which bias the sample distribution to generate an inaccurate estimation of the actual distribution. For the above reasons, operators of Markov Chain Monte Carlo typically discard a certain portion of initial samples—corresponding to the burn-in area shown—in order to avoid this skewing of the sample distribution. The number of samples discarded is highly domain specific and is not necessarily analytically calculable. However, the burn-in period—the amount of time it takes to generate these samples and move the sample generator to an area of “high” distribution—represents a substantial portion of the simulation time.

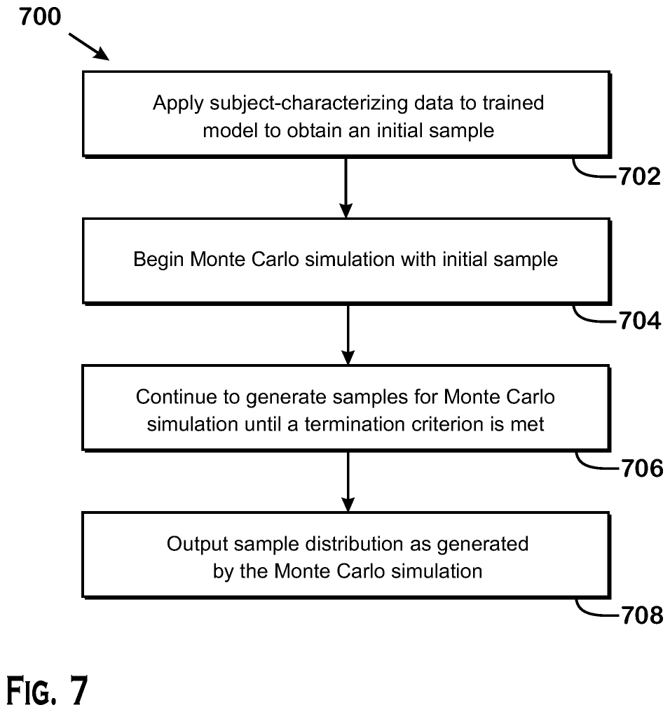

FIGS. 5 and 6 illustrate a technique for reducing or eliminating the burn-in period, according to an example. The technique includes generating a trained machine learning network and utilizing the trained machine learning network to generate an initial sample for Markov Chain Monte Carlo operations. The model attempts to generate the initial sample having a value that is within a “high probability” portion of the actual distribution. If such a sample were generated accurately enough, the burn-in period could be avoided, because, the simulator would not have to “traverse” to the “correct” area of the actual distribution before collecting “useful” samples. Even if there were some degree of inaccuracy for the initial sample, if the initial sample were substantially close to the “correct,” area then the burn-in operations could be shortened.

FIG. 5 illustrates a training operation 500, according to an example. A model generator 502 is software executing on a processor configured to perform the operations described herein, hardware circuitry configured to perform the operations described herein, or a combination of software executing on a processor and hardware circuitry that together perform the operations described herein. According to the training operation 500, a model generator 502 generates an initial sample machine learning model 504 based on a set of training data items 506. The initial sample machine learning model 504 has any technically feasible machine learning network architecture. In an example, the machine learning model 504 is a classifier trained with supervised training. The machine learning model 504 is trained to produce an initial sample output given an input set of distribution-characterizing data. This initial sample output is used to begin the Markov Chain Monte Carlo operations as described elsewhere herein.

To train the model, a model generator 502 accepts the training data items 506 and trains the machine learning model 504 based on those training data items 506. Each training data item 506 is associated with a particular probability distribution. Specifically, the distribution characterizing data 510 is data that characterizes the probability distribution in some way. In some examples, the distribution characterizing data 510 is data that characterizes a mathematical description of the probability distribution. In an example, the distribution characterizing data 510 includes coefficients for a function associated with the probability distribution, such as the density function or a different function. In some examples, the distribution characterizing data 510 also or alternatively includes numerical values for one or more parameters for a mathematical function that mathematically descries the probability distribution. In various examples, the distribution characterizing data 510 includes statistical parameters, such as a distribution type (e.g., Normal, Weibull), mean, standard deviation, and scale parameter. In various examples, the distribution characterizing data 510 includes a parametric description of a physical model that is being modeled statistically with the distribution. In an example, the Monte Carlo simulation is performed to determine an electron density distribution for a configuration of atoms. In this example, the distribution characterizing data 510 includes parameters such as the types of the atoms (e.g., element number and isotope number) and the positions of the atoms. In other examples, the Monte Carlo simulation is performed to determine other physical characteristics of other systems, and the distribution characterizing data 510 includes one or more physical parameters of those systems.

The high-density sample 508 is a sample for the probability distribution associated with the training data item 506. The notion that the sample 508 is “high density” means that the sample is in an area of high probability for a particular probability distribution. There are many possible ways to characterize a “high density” sample. In an example, the high density sample is the mean of a probability distribution. (For a vector, in some examples, the mean is a vector including the mean of each element in the vectors of the probability distribution.). In other examples, the high density sample is the median, mode, or other value that is found within a part of the probability distribution that has “high probability” within that distribution. In some examples, the high-density sample is the sample having the highest value for the probability density function. In an example, the high-density sample is a point that nearly satisfies the governing equations in integral form.

In other words, the training data items 506 are items with which the model generator 502 trains the initial sample machine learning model 504 to generate a high-density sample (label) for a probability distribution when provided with data characterizing that probability distribution. The training data items 506 provide labels in the form of high-density samples 508, and input data in the form of distribution-characterizing data 510. The model generator 502 trains the model 504 to produce a high-density sample 508 in response to input data that is analogous to the distribution-characterizing data 510.

FIG. 6 illustrates a simulator system 600 for generating initial samples for a Markov Chain Monte Carlo simulation performed by a Monte Carlo simulator 602. An inference system 604 has access to the initial sample machine learning model 504 and generates initial samples to the Monte Carlo Simulator 602. The Monte Carlo simulator 602 and inference system 604 are embodied as software executing on a processor configured to perform the operations described herein, hardware circuitry configured to perform the operations described herein, or a combination of software executing on a processor and hardware circuitry that together perform the operations described herein.

FIG. 7 is a flow diagram of a method 700 for performing a Monte Carlo simulation, according to an example. Although described with respect to the system of FIGS. 1-6, it should be understood that any system, configured to perform the steps of the method 700 in any technically feasible order, falls within the scope of the present disclosure. FIGS. 6 and 7 are now discussed together.

At step 702, the simulator system 600 accepts subject-characterizing data which characterizes a probability distribution that the simulator system 600 is trying to generate a sample distribution for. The subject-characterizing data is similar to the distribution-characterizing data in that the subject-characterizing data is associated with and characterizes a particular probability distribution that the simulator system 600 is attempting to determine through simulation. In various examples, the simulator system 600 obtains this subject-characterizing data automatically from a computer system or from input provided by a human operator. The simulator system 600 applies the subject-characterizing data to the inference system 604. The inference system 604 applies the subject-characterizing data to the initial sample machine learning model 504, which outputs an initial sample. The inference system 604 provides this initial sample to the Monte Carlo simulator 602, which performs a Monte Carlo simulation starting with the initial sample.

At step 704, the Monte Carlo simulator 602 performs a Markov Chain Monte Carlo simulation using the generated initial sample. In various examples, the Monte Carlo simulator 602 performs the simulation as described elsewhere herein. The Monte Carlo simulator 602 includes the initial sample into the sample distribution. At step 706, the Monte Carlo simulator 602 generates a new sample based on that initial sample, by modifying the initial sample by a random amount. The Monte Carlo simulator 602 determines whether to include the generated sample into the sample distribution or to discard the sample based on inclusion criteria. Some examples of inclusion criteria, such as the Metropolis-Hastings algorithm, are described elsewhere herein. The Monte Carlo simulator 602 includes the sample into the sample distribution if the inclusion criteria indicates that the sample should be included and does not include the sample if the inclusion criteria indicates that the sample should not be included. The Monte Carlo simulator 602 generates another sample in a similar manner from the most recently added sample, and determines whether to add that sample to the sample distribution based on inclusion criteria as described above. The Monte Carlo simulator 602 continues generating samples and adding accepted samples to the sample distribution until a termination criterion is met. In examples, the termination criterion includes that a certain number of samples have been generated or that the Monte Carlo simulator 602 receives a termination signal from, for example, a user. At step 708, the Monte Carlo simulator 602 outputs the generated sample distribution as the resulting sample distribution.

Use of the initial sample that is in a “high-probability” area of the probability distribution that is being estimated helps to reduce or eliminate the burn-in period. In the example of FIGS. 3 and 4, if the initial sample had a value of 20 instead of 0, then the simulator would not have to dwell in the burn-in region 302 prior to arriving at the high probability region. Thus, fewer samples would need to be generated because a large number of samples would not need to be discarded. Even if the value were somewhat close to 20 (for example, 10), the number of samples that would be collected before the simulator reached the area of high probability would be lower than in the case of a bad randomly generated initial sample such as zero. For this reason, in some implementations, the simulator system 600 does not perform a burn-in operation. In other words, in some implementations, the simulator system 600 discards none of the samples generated. In other implementations, burn-in, and thus discarding of samples, is still performed, but fewer samples are discarded as compared with the situation where the inference system 604 is not used to generate the initial sample.

In various implementations, the inference system 604, Monte Carlo simulator 602, and model generator 502 are located within a computer system such as the computer system 100 of FIG. 1. In various examples, the inference system 604, the Monte Carlo simulator 602, and the model generator 502 are computer programs executing on the processor 102 or are included within devices such as input devices 108. In various examples, the inference system 604, Monte Carlo simulator 602, and model generator 502 are in the same computer system 100 or in a different computer system. In an example, one computer system 100 includes the model generator 502, which therefore generates the model 504. This computer system 100 provides the generated model 504 to a different computer system 100. This different computer system 100 includes the inference system 604 and the Monte Carlo simulator 602 and performs the method 700 to perform the Monte Carlo simulation. In another example, one computer system 100 includes the model generator 502, the inference system 604, and the Monte Carlo simulator 602. This one computer system 100 thus generates the model 504 and uses that model to generate an initial sample for the Monte Carlo Simulator 602, to perform a Monte Carlo simulation.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a graphics processor, a machine learning processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method, comprising:
obtaining an initial Monte Carlo simulation sample from a trained machine learning model, and including the initial Monte Carlo simulation sample in a sample distribution;
generating a subsequent Monte Carlo simulation sample from a most recently included Monte Carlo simulation sample most recently included into the sample distribution;
determining whether to include the subsequent Monte Carlo simulation sample into the sample distribution based on an inclusion criterion; and
repeating the generating and determining steps until a termination criterion is met.

2. The method of claim 1, wherein obtaining the initial Monte Carlo simulation sample comprises:
applying the subject characterizing data to the trained machine learning model, to generate the initial Monte Carlo simulation sample.

3. The method of claim 1, further comprising:
generating the trained machine learning model.

4. The method of claim 3, wherein generating the trained machine learning model comprises:
applying a set of training data items that include distribution-characterizing data and high-density samples to a model generator to generate the trained machine learning model.

5. The method of claim 1, further comprising:
foregoing discarding burn-in samples from the sample distribution.

6. The method of claim 1, further comprising:
discarding burn-in samples from the sample distribution.

7. The method of claim 1, wherein the inclusion criterion includes a comparison between a randomly generated number and a density function ratio of the subsequent Monte Carlo simulation sample and the most recently included Monte Carlo simulation sample.

8. The method of claim 1, wherein the termination criteria comprises including a threshold number of simulation samples into the sample distribution.

9. The method of claim 1, wherein the termination criteria comprises receiving a termination indication.

10. A system, comprising:
an inference system configured to obtain an initial Monte Carlo simulation sample from a trained machine learning model, and including the initial Monte Carlo simulation sample in a sample distribution; and
a Monte Carlo simulator configured to:
generate a subsequent Monte Carlo simulation sample from a most recently included Monte Carlo simulation sample most recently included into the sample distribution;
determine whether to include the subsequent Monte Carlo simulation sample into the sample distribution based on an inclusion criterion; and
repeat the generating and determining steps until a termination criterion is met.

11. The system of claim 10, wherein obtaining the initial Monte Carlo simulation sample comprises:
providing subject characterizing data to the inference system; and
applying, via the inference system, the subject characterizing data to the trained machine learning model, to generate the initial Monte Carlo simulation sample.

12. The system of claim 10, further comprising:
a model generator configured to generate the trained machine learning model.

13. The system of claim 12, wherein generating the trained machine learning model comprises:
applying a set of training data items that include distribution-characterizing data and high-density samples to a model generator to generate the trained machine learning model.

14. The system of claim 10, wherein the Monte Carlo simulator is further configured to:
forego discarding burn-in samples from the sample distribution.

15. The system of claim 10, wherein the Monte Carlo simulator is further configured to:
discard burn-in samples from the sample distribution.

16. The system of claim 10, wherein the inclusion criterion includes a comparison between a randomly generated number and a density function ratio of the subsequent Monte Carlo simulation sample and the most recently included Monte Carlo simulation sample.

17. The system of claim 10, wherein the termination criteria comprises including a threshold number of simulation samples into the sample distribution.

18. The system of claim 10, wherein the termination criteria comprises receiving a termination indication.

19. The non-transitory computer-readable medium storing instructions that, when executed by a processor, cause the processor to:
obtain an initial Monte Carlo simulation sample from a trained machine learning model, and including the initial Monte Carlo simulation sample in a sample distribution;
generate a subsequent Monte Carlo simulation sample from a most recently included Monte Carlo simulation sample most recently included into the sample distribution;
determine whether to include the subsequent Monte Carlo simulation sample into the sample distribution based on an inclusion criterion; and
repeat the generating and determining steps until a termination criterion is met.

20. The non-transitory computer-readable medium of claim 19, wherein obtaining the initial Monte Carlo simulation sample comprises:
applying subject characterizing data to the trained machine learning model to generate the initial Monte Carlo simulation sample.
